(19) United States
(12) Patent Application Publication
(10) Pub. No.: US 2019/0108765 A1
(43) Pub. Date: Apr. 11, 2019

(54) SYSTEM AND METHOD FOR NAVIGATING AN AIRCRAFT IN A HANGAR

(71) Applicant: Airbus Operations GmbH, Hamburg (DE)

(72) Inventors: Rolf Bense, Jork (DE); Daniel Lahidjanian, Hamburg (DE); Misha Kappelhoff, Jork (DE)

(21) Appl. No.: 16/138,399

(22) Filed: Sep. 21, 2018

(30) Foreign Application Priority Data
Oct. 6, 2017 (DE) 10 2017 123 195.1

(51) Int. Cl. G08G 5/06; B64F 1/22; G05D 1/02; B64D 47/08

(52) U.S. Cl. CPC G08G 5/065; B64D 47/08; G05D 1/0202; B64F 1/222

(57) ABSTRACT

A system for navigating an aircraft in a hangar, having at least one optical sensor firmly connected to the aircraft. The sensor can be used to continuously capture surroundings contour data relative to the aircraft. A data processing apparatus, connected to the sensor, has a data memory storing reference data and can be used to determine an aircraft actual position by continuously matching captured surroundings contour data with the reference data and to identify a position deviation by comparing the determined actual position with a stored target position. Also, a method for navigating an aircraft in a hangar with such a system.

### CROSS-REFERENCES TO RELATED APPLICATIONS

This application claims the benefit of the German patent application No. 10 2017 123 195.1 filed on Oct. 6, 2017, the entire disclosure of which is incorporated herein by way of reference.

### FIELD OF THE INVENTION

The invention relates to a system and method for navigating an aircraft in a hangar.

### BACKGROUND TO THE INVENTION

Aircraft are removed from ongoing operation and towed into hangars in order to perform maintenance measures or repair measures, for example. Further, almost completely finished aircraft are also maneuvered, for example for the purpose of performing painting work at the end of an aircraft manufacturing process, into painting hangars provided for this purpose. Both the maintenance and/or repair measures and the painting work normally require the aircraft to be positioned in the hangar, allowing work platforms and/or special tools to be subsequently brought up to the aircraft. It is of great importance in this case for accurate position identification and, subsequently, positioning to be possible in order to be able to perform the appropriate work on the aircraft quickly.

Conventionally, positioning involves the use of plumb lines that are attached by workers to the wing tips, for example, or to other predetermined points on the aircraft and need to be brought into particular areas predetermined on the hangar floor by appropriately maneuvering the aircraft in the hangar, in order to reach the desired parking position.

In order to hit the desired parking positions of the aircraft, it is normally necessary for several people to be involved in the process and to monitor it, since one person alone typically cannot see all areas at the same time. Readjustments may also be necessary, but these take time and can delay the start of planned measures.

It is an object of the invention to provide the most accurate and fastest possible position identification for an aircraft inside a hangar, in particular during navigation of the aircraft into or out of the hangar.

### SUMMARY OF THE INVENTION

An object of the invention is achieved by a system for navigating an aircraft in a hangar, having at least one optical sensor firmly connected to the aircraft, wherein the sensor can be used to continuously capture surroundings contour data relative to the aircraft, and having a data processing apparatus, connected to the sensor, that has a data memory storing reference data, wherein the data processing apparatus can be used to identify an actual position of the aircraft in the hangar by continuously matching captured surroundings contour data with the reference data. The system according to the invention allows the aircraft position relative to the aircraft surroundings to be identified in an automated manner. This allows a desired position or target position for the aircraft to be taken up in the hangar. In this manner, a desired position can be taken up more quickly and the subsequent work (painting by automatically acting painting apparatuses or maintenance or repair measures) can be started more quickly. On the basis of increasing automation, it can be expected that, in particular for work beginning on the aircraft exterior by robots, for example, or otherwise automated tools, faster and more accurate position identification and therefore positioning is advantageous.

According to the invention, the sensor is connected to the data processing apparatus such that data communication between sensor and data processing apparatus is possible. In other words: data signals can be interchanged between sensor and the data processing apparatus. By way of example, the data processing apparatus is fitted to the aircraft and electrically conductively connected to the sensor(s) via data cable.

According to the invention, the surroundings contour data are captured in 360° surroundings of the aircraft. Typical ranges of the surroundings contour data capture in this case are up to approximately 80 meters. According to the invention, the surroundings contour can be captured in polar coordinates. The surroundings contour data are captured continuously, i.e. at repeated times or at successive intervals of time, according to the invention.

A preferred embodiment of the system is characterized in that the surroundings contour data capturable are hangar interior contour data, and in that the stored reference data are hangar interior contour reference data, wherein matching thereof allows the actual position of the sensor relative to the hangar interior contour to be determined. The system according to this embodiment can determine the actual position of the sensor relative to the hangar interior contour. Accordingly, the aircraft can be specifically positioned in the hangar.

The hangar interior contour reference data are interior contour data of the hangar that are previously known or predefined (and are available, e.g., in stored form in the data memory). Since the sensor is firmly connected to the aircraft and therefore its relative position in relation to the aircraft always remains unchanged, the actual position (and also the actual orientation) of the whole aircraft is indirectly also known whenever the actual position of the sensor has been determined or is known. Preferably, reflectors may be arranged along the hangar interior contour. This advantageously increases the accuracy when capturing the hangar interior contour or the surroundings contour data, and therefore the accuracy of the actual position of the sensor.

In a likewise preferred embodiment of the system, the data processing apparatus can be used to identify a position deviation by comparing the determined actual position with a target position. As a result of the identification of the position deviation and the continuous provision thereof, it is advantageously possible for the process of taking the aircraft into or out of the hangar to be monitored and for an early assessment to be made as to whether the target position of the aircraft will be reached or whether early action should be taken in the process of bringing the aircraft into or out of the hangar in order to reach the target position. In particular for fine adjustment or fine positioning at the end of a process of bringing an aircraft into or out of the hangar, the identification of the position deviation is useful. Once the target position has been reached, the position deviation is zero and a signal, which is audible or else visually perceptible, for example, can be output by the system.

An embodiment is also preferred in which the optical sensor is arranged on the nose gear of the aircraft such that in the extended state of the nose gear the sensor can see a monitoring area that comprises two lateral aircraft areas and a front aircraft area. In this manner, primarily that area of the aircraft surroundings that is generally of most relevance in the case of aircraft being taxied into the hangar forwards is captured. The two lateral aircraft areas typically comprise all of the areas around the two wings. The front aircraft area typically comprises the whole front fuselage area and an area adjoining that in the direction of forward flight.

Further, an embodiment is particularly preferred which comprises at least one further optical sensor that can continuously capture additional surroundings contour data and that is connected (for data communication purposes) to the data processing apparatus. The additional capture of surroundings contour data can improve the position identification by, for example, increasing the accuracy thereof. The geometrically capturable area of the system can thus be enlarged (for example this can also allow surroundings contour data capture in the reverse direction of the aircraft). Further, the one or more optical sensors can be arranged at different levels of the aircraft such that surroundings contour data are captured in all areas surrounding the aircraft.

In a further preferred embodiment of the system, the optical sensor(s) are configured as optoelectronic sensors, in particular as two-dimensional laser scanners. An optoelectronic sensor or a two-dimensional laser scanner is able, for example by means of rotation of a laser scanning beam within a two-dimensional plane and reception of reflections of a scanning beam (i.e. reflections from items intersecting this two-dimensional plane), to produce a two-dimensional geometry of the captured 360° surroundings as surroundings contour data (e.g., of the interior of an aircraft hangar, that is to say what are known as hangar interior contour data). The reflections produced by the rotating scanning beam can be received again by the optoelectronic sensor or laser scanner, the distance of the reflecting items being able to be captured as surroundings contour data from the propagation time. Such surroundings contour data are typically specified as polar coordinates in the case of rotating capture. The optoelectronic sensor(s) or two-dimensional laser scanner(s) may fundamentally be battery operated, the battery either being able to be provided individually on the respective sensor or being able to be fitted to the aircraft. Further, it is alternatively possible for the sensors to be connected to the aircraft's electrical system in order to supply the sensors with electric power.

An embodiment is also preferred in which the aircraft is provided with at least one coupling device that can be used to detachably connect the optical sensor(s) to the aircraft. The optical sensor is therefore able to be used in a navigation position connected to the aircraft in rotationally fixed manner (i.e. in nonrotational manner). Further, the sensor can be detached or removed from the aircraft again after successful hangar navigation or successful hangar positioning. In order to ensure that the sensor(s) connected to the coupling device in rotationally fixed manner have a correct relative position in relation to the remainder of the aircraft, the sensors can each capture the aircraft geometry surrounding them and match the captured aircraft geometry with a target aircraft geometry in order to check whether they are correctly oriented or whether they have possibly been used incorrectly (with an unwanted orientation relative to the aircraft). In the latter case, an applicable warning tone can be outputted, so that correct use can take place subsequently.

In a preferred development of the preceding embodiment, the data processing apparatus is fitted in a hangar and the data processing apparatus and the optical sensor(s) have a transmission and reception device for sending and receiving surroundings contour data and reference data. In this manner, the data processing apparatus may advantageously be arranged separately from the aircraft and can communicate with the sensor(s) via the transmission and reception devices. There is therefore no need for provision of the data processing apparatus on the aircraft, this advantageously being linked to a corresponding weight saving. The data processing apparatus can communicate with the sensor(s) by means of a WLAN (wireless local area network), for example.

An object is likewise achieved by a method for navigating an aircraft in a hangar, having the method steps of: continuously capturing hangar interior contour data relative to the aircraft as surroundings contour data by means of an optical sensor firmly connected to the aircraft; matching the captured hangar interior contour data with hangar interior contour reference data as reference data, in order to continuously determine an actual position of the optical sensor relative to the hangar interior contour. The method according to the invention is substantially associated with the same advantages as the system according to the invention for identifying the actual position of the aircraft in the hangar.

One preference is also a method variant of the preceding method that is characterized by the further method steps of: comparing the determined actual position with a stored target position and identifying a position deviation. This advantageously allows the process of bringing the aircraft into or out of the hangar to be monitored, and early detection to be performed as to whether the target position of the aircraft will probably be reached or whether corrective action should be taken in the process of bringing the aircraft into or out of the hangar in order to reach the target position.

The aspects and further aspects, features and advantages of the invention that are described above can likewise be taken from the examples of the embodiment that is described below with reference to the appended drawings.

### BRIEF DESCRIPTION OF THE DRAWINGS

In the figures, the same reference signs are used for elements, components or aspects that are the same or at least similar. It is noted that there follows a detailed description of embodiments that are merely illustrative and not restrictive. In the claims, the word “having” does not exclude other elements and the indefinite article “a” or “an” does not exclude more than one. The fact alone that certain features are mentioned in various dependent claims does not restrict the subject matter of the invention. Combinations of these features can also be advantageously used. The reference signs in the claims are not intended to restrict the scope of the claims. The figures are not to be understood as true to scale but are only of a schematic and illustrative character. In the figures:

FIG. 1 shows a plan view of a hangar and of an aircraft having a system according to the invention for navigating the aircraft in the hangar according to a first embodiment, wherein the aircraft has not reached its target position in the depicted situation,

FIG. 2 shows a plan view of the hangar and the aircraft shown in FIG. 1, wherein the aircraft has reached the target position in the depicted situation,

FIG. 3 shows a plan view of a system for navigating an aircraft in a hangar according to a further embodiment, in which a data processing apparatus is arranged on the aircraft,

FIG. 4 shows a plan view of a system for navigating an aircraft in a hangar according to another embodiment, in which a data processing apparatus is arranged in the hangar, and

FIG. 5 shows a schematic depiction of a method according to the invention for navigating an aircraft in a hangar as shown in FIGS. 1 and 2.

### DETAILED DESCRIPTION OF THE PREFERRED EMBODIMENTS

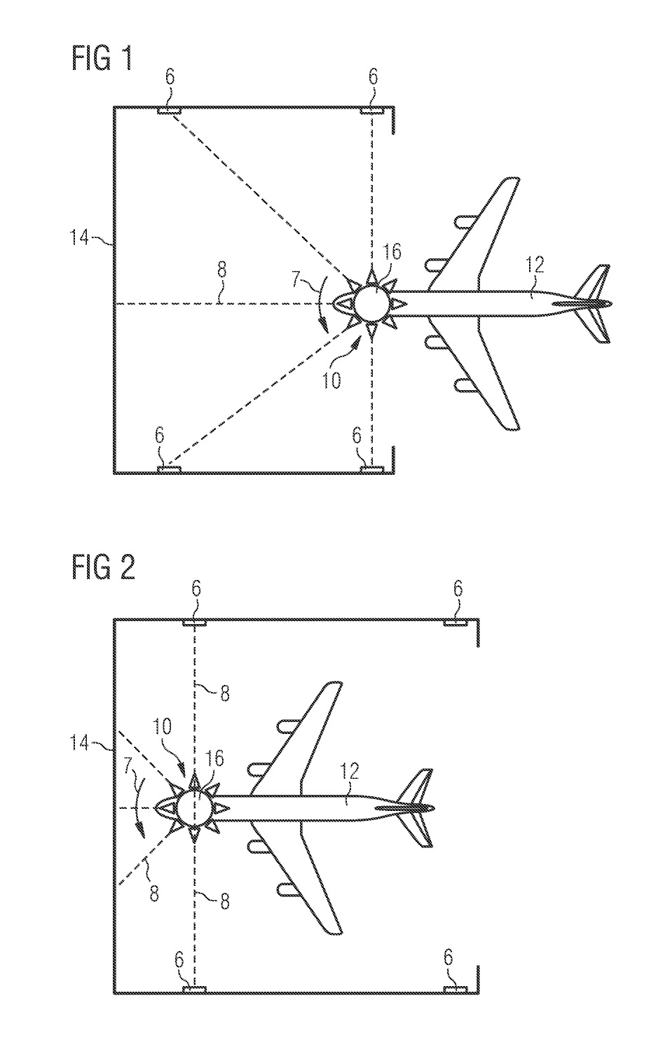

FIG. 1 shows a hangar 14 and an aircraft 12 having a system 10 for navigating the aircraft 12 in the hangar 14. The system 10 is suitable for identifying an actual position of the aircraft in the hangar 14. In the situation depicted in FIG. 1, which can arise when the aircraft 12 is being brought into or taken out of the hangar 14, for example, the aircraft 12 is not in a target position. Accordingly, a position deviation between the determined actual position and a target position of the aircraft exists in this situation.

The system 10 comprises an optical sensor 16, firmly connected to the aircraft 12, that can be used to continuously capture surroundings contour data relative to the aircraft 12. In FIG. 1, the sensor 16 is configured as a two-dimensional laser scanner that firstly transmits a scanning beam 8 in rotating manner (cf. arrow 7) and secondly receives reflections that arise along the hangar interior contour or along reflectors 6 arranged on the hangar inside 14 as a result of the incident scanning beam 8. In this manner, the sensor 16 can capture surroundings contour data relative to the aircraft 12.

FIG. 2 shows the aircraft 12 having the system 10 shown in FIG. 1, in a situation in which the aircraft 12 is positioned relative to the hangar 14 such that it has reached the target position. Accordingly, no position deviation between the determined actual position and the target position of the aircraft exists in this situation.

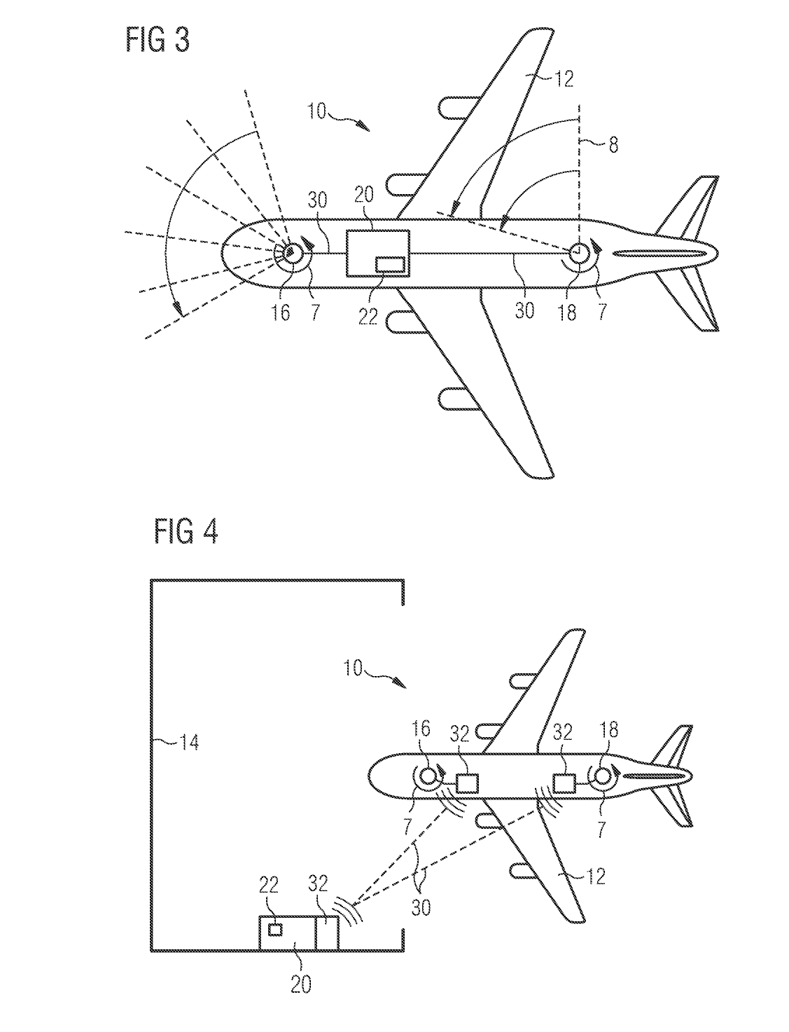

FIG. 3 shows those components of a system 10, which, as shown in FIGS. 1 and 2, is suitable for identifying an actual position of the aircraft in the hangar 14, that are installed on the aircraft. The system 10 comprises a first optical sensor 16, firmly connected to the aircraft 12, and a second sensor 18, likewise firmly connected to the aircraft 12. The sensors 16, 18 are suitable for continuously capturing surroundings contour data relative to the aircraft 12 and may in particular be configured as optoelectronic sensors or as two-dimensional laser scanners. As such, they can transmit a rotating scanning beam 8 (cf. arrow 7) and receive reflections from surroundings contours, wherein the distances of the reflecting objects are derivable from the propagation time of the reflections and are capturable as surroundings contour data in polar coordinates. The system 10 further comprises a data processing apparatus 20, which is connected to the first and second sensors 16, 18 via data cable 30 and has a data memory 22.

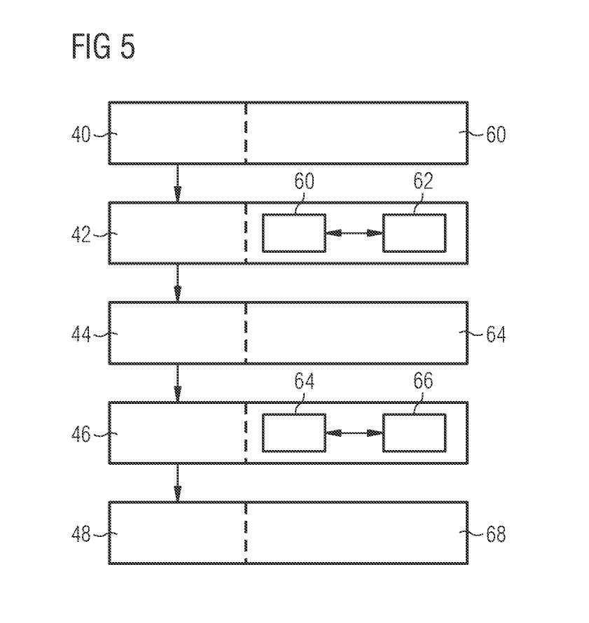

FIG. 4 depicts an alternative embodiment to FIG. 3, in which the data processing apparatus 20 is fitted in a hangar and the data processing apparatus 20 and the optical sensor(s) 16, 18 each have a transmission and reception device 32 for sending and receiving data. As this system 10 dispenses with a data processing apparatus 20 arranged on the aircraft, it is advantageously possible for the weight of said apparatus to be saved on the aircraft. The data processing apparatus 20 fitted in the hangar can communicate with the sensor(s) 16, 18 via a WLAN, for example. The data memory 22 is integrated in the data processing installation 20, for example. The arrows 7 depicted in the area of the two sensors 16, 18 indicate the direction of rotation of the scanning beams 8 of the optoelectronic sensors 16, 18.

In particular in the case of the embodiment of the system 10 that is depicted in FIG. 4, the aircraft may be provided with at least one coupling device, not depicted, that allows the optical sensor(s) 16, 18 along with the corresponding transmission and reception devices 32 to be detachably mounted on the aircraft 12. This means that the sensors 16, 18 and sensor transmission and reception devices 32 can be kept to a certain extent loose from (or independent of) the aircraft 12 and connected to the aircraft's coupling device in rotationally fixed manner by workers for the purpose of the navigation in the hangar 14. After navigation has taken plane, the sensors 16, 18 together with the corresponding transmission and reception devices 32 can be removed from the coupling device or the aircraft 12 again. In this manner, no further components of the system 10 need to be permanently provided on the aircraft apart from the coupling device.

FIG. 5 uses a schematic block diagram to show the basic flow of a method for navigating an aircraft 12 in a hangar 14, as performed by the previously described systems 10 shown in FIGS. 3 and 4. The method allows an actual position 64 of the aircraft in the hangar 14 to be identified (cf. FIGS. 1 and 2). In a first method step, hangar interior contour data 60 are continuously captured 40 for this purpose relative to the aircraft 12 as surroundings contour data by means of an optical sensor 16, 18 firmly connected to the aircraft 12. Subsequently, the continuously captured hangar interior contour data 60 are matched 42 with previously known hangar interior contour reference data 62 in order to continuously determine 44 the actual position 64 of the optical sensor 16, 18 relative to the hangar interior contour. Finally, in a last method step, a position deviation 68 can be identified 48 by comparing 46 the actual position 64 determined by means of the data processing apparatus 20 with a target position 66 which is likewise stored.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A system for navigating an aircraft in a hangar, comprising:
at least one optical sensor firmly connected to the aircraft, wherein the at least one optical sensor is configured to be used to continuously capture surroundings contour data relative to the aircraft, and
a data processing apparatus, connected to the at least one optical sensor, the data processing apparatus comprising a data memory storing reference data,
wherein the data processing apparatus is configured to identify an actual position of the aircraft in the hangar by continuously matching captured surroundings contour data with the reference data.

2. The system according to claim 1, wherein the surroundings contour data comprise hangar interior contour data, and wherein the stored reference data comprise hangar interior contour reference data, and wherein matching thereof allows an actual position of the sensor relative to the hangar interior contour to be determined.

3. The system according to claim 2, wherein the data processing apparatus is configured to identify a position deviation by comparing the actual position of the aircraft in the hangar with a target position.

4. The system according to claim 1, wherein the at least one optical sensor is arranged on a nose gear of the aircraft such that in an extended state of the nose gear a monitoring area that comprises a lateral aircraft area and a front aircraft area is visible for the sensor.

5. The system according to claim 1, further comprising:
at least one further optical sensor that configured to continuously capture additional surroundings contour data and the least one further optical sensor connected to the data processing apparatus.

6. The system according to claim 1, wherein the aircraft optical sensor is configured as optoelectronic sensors.

7. The system according to claim 1, wherein the aircraft is provided with at least one coupling device configured to detachably connect the at least one optical sensor to the aircraft.

8. The system according to claim 7, wherein the data processing apparatus is arranged in a hangar and the data processing apparatus and the at least one optical sensor have a transmission and reception device for sending and receiving surroundings contour data and reference data.

9. A method for navigating an aircraft in a hangar, the method comprising the steps of:
continuously capturing hangar interior contour data relative to the aircraft as surroundings contour data with an optical sensor firmly connected to the aircraft; and,
matching the captured hangar interior contour data with hangar interior contour reference data as reference data in order to continuously determine an actual position of the optical sensor relative to the hangar interior contour.

10. The method according to claim 9, further comprising the steps of:
comparing the determined actual position with a stored target position; and,
identifying a position deviation.

11. The system according to claim 1, wherein the at least one optical sensor is configured as a two-dimensional laser scanner.
